(19) United States
(12) Patent Application Publication
(10) Pub. No.: US 2013/0103962 A1
(43) Pub. Date: Apr. 25, 2013

(54) SLEEP STATE SYNCHRONIZATION METHOD BETWEEN DOCKED TERMINALS AND DOCKING SYSTEM USING THE SAME

(71) Applicants: Byeong-Nam AHN, Seong nam (KR); Syeung-il KIM, Seong nam (KR); Young-Mook CHO, Seong nam (KR)

(72) Inventors: Byeong-Nam AHN, Seong nam (KR); Syeung-il KIM, Seong nam (KR); Young-Mook CHO, Seong nam (KR)

(73) Assignee: HANDONG LNC CO., LTD., Seongnam-si (KR)

(21) Appl. No.: 13/281,402

(22) Filed: Oct. 25, 2011

(51) Int. Cl. G06F 1/00

(52) U.S. Cl. 713/323

(57) ABSTRACT

A sleep state synchronization method between docked terminals and docking system using the same is disclosed. The state synchronization method between docked terminals includes determining whether or not a first terminal is docked on a second terminal, turning off signal transmitted to a TMDS data line when it is determined that the first terminal is not docked on the second terminal, and the entering by the second terminal into sleep mode. Accordingly, the docked terminals are able to enter into sleep mode together, enabling interlocked operations of the docked terminals instead of operating independently, which would prevent confusion to users when using the docked terminals. In addition, by the aforementioned method, it is unnecessary to make settings for each docked terminal separately, and it is possible to enter into sleep mode easily using TMDS signal of a HDMI interface without going through complex algorithms.

### BACKGROUND OF THE INVENTION

1. Field of the Invention

Methods and apparatuses consistent with the exemplary embodiments relate to a sleep state synchronization method between docked terminals and docking system using the same, and more particularly, to a sleep state synchronization method between docked terminals for, in the case where one of the docked terminals enters into a sleep mode, notifying the state to the other terminals to enable the other terminals to enter into the sleep mode as well, and a docking system using the same.

2. Description of the Prior Art

Due to the recent remarkable development of communication technology and popularization of smart phones, a lot of people have smart phones nowadays not merely for telephoning purposes but also for various purposes such as entertainment, writing documents, trading stocks, playing multimedia, and maintaining social relationships etc.

However, a smart phone is equipped with a limited interface device, unlike those used in computers such as mass storage devices, backup devices, and local printers. Moreover, since smart phones are designed with priority consideration given to portability, it is true that the size of display is limited and that the size of buttons and items on a screen is small, making it difficult for a user to manipulate the device quickly and easily.

Therefore, in reality most of the smart phone users perform necessary operations or work through a separate device such as a desktop, notebook, and laptop when they are at home, and use their smart phones only in situations where they cannot use a separate device.

However, if a user is to use an application or environment that he/she used in a smart phone in a separate device once again, there is inconvenience of having to transfer the data stored in the smart phone to the separate device.

In order to increase convenience when using a smart phone which has limited interface device, a docking station for providing an additional input/output interface device is used. When using the docking station, the user is able to use an extension slot, external memory device, dialogue surface display, keyboard, mouse, and local printer, which increases efficiency of operations or work. Furthermore, since the user could use the application and environment that he/she used in the smart phone, the operations or work can be continued.

However, to interlock the docked terminals and take into account the convenience of the users using the docked terminals, it is necessary to make sure the terminals are kept interlocked and that one particular terminal do not operate differently from the other terminals. One of the cases where such an independent event may occur is when a smart phone and separate devices have different settings for entering sleep mode, thereby each entering into sleep modes differently. That is, since the each terminal has different time set to enter into sleep mode depending on its manufacturer, hardware configuration or a user's setting, unless there is additional operation to synchronize the entering times of the docked terminals, the docked terminals will enter into sleep mode at the time set for each terminal.

However, if a terminal has already entered into sleep mode but the other terminal has not entered into sleep mode, a user who doesn't know the state of the terminal which entered into sleep mode may experience confusion regarding the operations of the terminal.

Therefore, it is necessary to seek a way to synchronize the times of entering into sleep mode of the two docked terminals.

### SUMMARY OF THE INVENTION

The purpose of the present disclosure is to provide a sleep state synchronization method for enabling the docked terminals to enter into sleep mode together.

According to an exemplary embodiment of the present disclosure, a method for synchronizing a state of a second terminal to a state of a first terminal in a case where the first terminal is docked on the second terminal through a plurality of interfaces may include determining by the first terminal whether or not the first terminal is interlocked to the second terminal; turning off signal which the first terminal transmits to a TMDS data line, when it is determined that the first terminal is not interlocked to the second terminal; and entering by the second terminal into sleep mode, when it is confirmed that the signal received from the TMDS data line is turned off.

Herein, the state synchronization method between docked terminals according to an exemplary embodiment of the present disclosure may further include determining whether or not the second terminal satisfies conditions for entering into sleep mode, wherein the entering by the second terminal may include the second terminal entering into sleep mode, when it is confirmed that the signal received from the TMDS data line is turned off, after satisfying conditions of entering into sleep mode.

In addition, the state synchronization method between docked terminals according to an exemplary embodiment of the present disclosure may further include determining whether or not the first terminal entered into an android sleep state which is applied in the android platform; wherein the determining may include the first terminal determining whether or not the first terminal is interlocked to the second terminal when the first terminal enters into the android sleep state.

Furthermore, the first terminal may be a mobile phone, and the second terminal may be a desktop, tablet PC or laptop which contains space where the first terminal can be docked on, and information processed in the mobile phone may be output in the desktop, tablet PC or laptop when the mobile phone is interlocked on the desktop, tablet PC or laptop.

According to an exemplary embodiment of the present disclosure, a system for synchronizing a state of a second terminal to a state of a first terminal in a case where the first terminal is docked on the second terminal through a plurality of interfaces may include a first terminal which turns off signal transmitted to a TMDS data line, when it is determined that the first terminal is not interlocked on the second terminal; and a second terminal which enters into sleep mode when it is determined that the signal received from the TMDS data line is turned off when conditions for entering into sleep mode are satisfied.

By the aforementioned, the docked terminals become able to enter into sleep mode together, and thus both terminals become able to perform interlocked events instead of performing independently, which would prevent confusion to users using the docked system.

In addition, using the aforementioned, it becomes unnecessary to make settings for each terminal, and becomes able to enter into sleep mode using TMDS signal of an HDMI interface without going through complex algorithms.

### BRIEF DESCRIPTION OF THE DRAWINGS

The above and/or other aspects of the present disclosure will be more apparent by describing certain present disclosure with reference to the accompanying drawings, in which:

FIGS. 1 and 2 are views illustrating a docking system where the present disclosure is applicable;

FIG. 3 is a block diagram of the aforementioned docking system;

FIG. 4 is a view partially illustrating an architecture layer under an android platform, as one of application systems which can be used in a smart phone and a smart pad; and

FIG. 5 is a flowchart used to explain a method for enabling the smart pad to enter into sleep mode as well, in the case where the smart phone is to enter into sleep mode.

### DETAILED DESCRIPTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

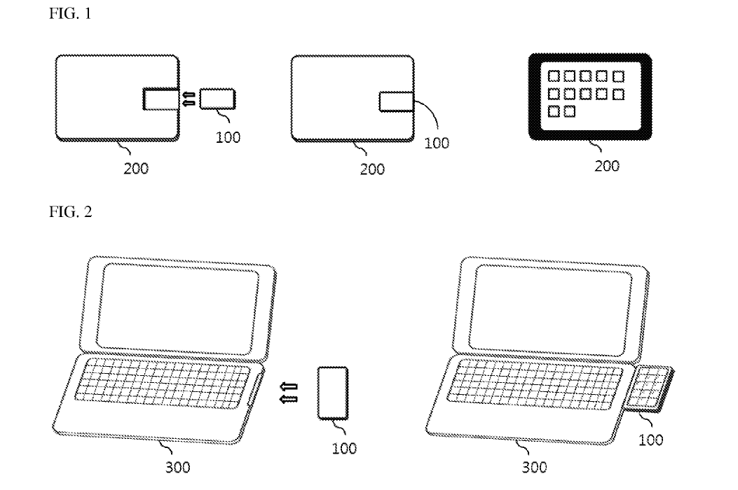

FIGS. 1 and 2 are views illustrating a docking system where the present invention is applicable.

First of all, FIG. 1 is a view illustrating the docking system for interlocking between a smart phone 100 and a smart pad 200. The smart phone 100 and the smart pad 200 may each be operated by separate operation systems, may drive separate application programs, and are equipped with separate devices. Of course, such operation systems and applications may be the same, similar, or different from each other, just as their provided devices may be the same, similar or different from each other.

For example, the smart phone 100 may be operated by an android operation system and drive application programs A, B, and C, while the smart pad 200 is operated by the same android operating system, but drive application programs B, C, and D. Similarly, the smart phone 100 may be equipped with a communication module for phone-calling and a camera module for photo-graphing, while the smart pad 200 is equipped with the same communication module for phone-calling, but also a camera module having higher specifications.

Since the smart phone 100 and the smart pad 200 are equipped with separate operating systems and thus operate according to separate operating systems, if they are not docked to each other as in the first illustration in FIG. 1, they are operated separately by their own operation systems.

However, in the smart phone 100 and the smart pad 200 according to the present disclosure, the smart phone 100 can be docked on a docking station located in a rear surface of the smart pad 200 as illustrated in the second illustration in FIG. 1. Of course, since the docking station is located in the rear surface of the smart pad 200, when using the smart pad 200 with the smart phone 100 docked on the smart pad 200, in order to prevent any input by error manipulation of the smart phone 100, the docking should be done in such a manner that a front surface of the smart phone 100 is not exposed, as in the second illustration in FIG. 1.

The third illustration in FIG. 1 is a screen which is operated by the operating system in the smart phone 100, or operated by the application program installed in the smart phone 100, after the smart phone 100 and the smart pad 200 are docked to each other.

As mentioned above, in the case of docking the smart phone 100 and the smart pad 200 and thereby interlocking the usage of the two terminals, a user is able to continue any operation or work that he/she used to do in the smart phone 100. Not only that, the user is able to use devices such as a display or a high-power speaker of the smart pad 200, which is an advantage of the smart pad 200, improving convenience of the user's operations or work.

Next, FIG. 2 illustrates a docking system for interlocking usage between the smart phone 100 and a laptop 300. The main difference of FIG. 1 from FIG. 2 is that in the docking system of FIG. 2, the smart phone 100 is not docked to be completely inserted into the docking system but is inserted partially into the docking station, enabling the smart phone 100 to function as a number pad for the laptop 300.

Therefore, unlike in FIG. 1, the smart phone 100 is docked on the laptop 300 in such a manner that a display of the smart phone 100 is exposed.

The third illustration in FIG. 2 is a screen where the smart phone 100 and the laptop 300 are docked on each other and thus are operated by an operating system or an application program provided in the smart phone 100.

Also by the aforementioned method, in the case of docking the smart phone 100 and the laptop 300 and thereby interlocking the usage of the two terminals, the user becomes able to continue any operation or work that he/she used to do in the smart phone 100 in the laptop 300. Not only that, the user can make use of the advantages of the laptop 300 as well.

Meanwhile, although in FIG. 2 the smart phone 100 is used as the number pad for the laptop 300, this is only an example for the convenience of explaining the present disclosure, and thus the technical concept of the present disclosure can also be applied when the smart phone 100 is used as a general touch pad instead of the number pad.

In addition, although in FIGS. 1 and 2, the smart phone 100 is docked on the smart pad 200 and the laptop 300, respectively, this is also only examples for convenience of explaining the present disclosure, and thus so long as separate terminals are docked to each other, such as the smart pad 200 and the laptop 300 being docked to each other or the smart phone 100 and a desktop (not illustrated) being docked to each other, these are all regarded to be within the scope of applying the present disclosure.

Furthermore, the docking locations or methods of the aforementioned smart phone 100 are also mere examples for the convenience of explaining the present disclosure, and thus the present disclosure could also be applied to cases of dockings by other methods and in locations not illustrated herein.

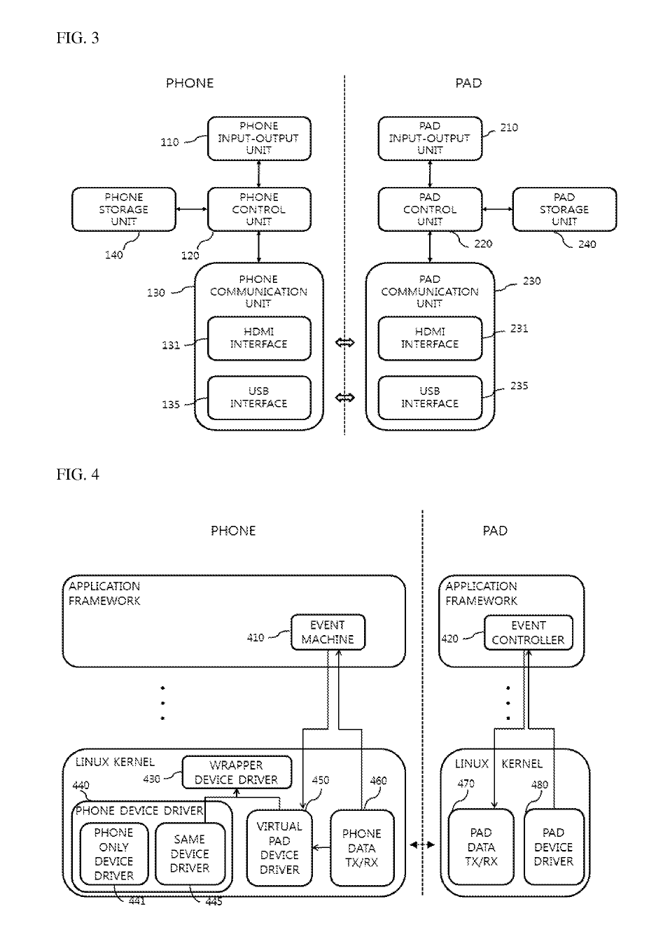

FIG. 3 is a block diagram of the aforementioned docking system. Hereinafter for convenience of explaining the present disclosure, the supposition will be that the smart phone 100 and the smart pad 200 are docked and interlocked to each other.

The smart phone 100 comprises a phone input-output unit 110, a phone control unit 120, a phone communication unit 130 and a phone storage unit 140.

The phone input-output unit 110 is used for the purpose of receiving signals input from a user or an external server or a terminal such as a touch screen, a button, and a speaker, and displaying the received signal on a screen or outputting them as voice.

The phone control unit 120 controls the phone input-output unit 110, the phone communication unit 130, and the storage unit 140 in such manners that the smart phone 100 can perform its functions properly. Especially, the phone control unit 120 controls the phone input-output unit 110 to process signals or user inputs received, and to display or output the processed results through the phone input-output unit 110. In addition, the phone control unit 120 controls the phone communication unit 130 to enable information exchange and data transmission and reception between the smart phone 100 and the smart pad 200. Not only that, the phone control unit 120 controls the phone storage unit 140 to store data transmitted to the phone input-output unit 100 and data transmitted and received through the phone communication unit 130, or to display data stored in the phone storage unit 140 through the phone input-output unit 110 or to transmit data to the smart pad 200.

Furthermore, the phone control unit 120 controls so that the smart phone 100 is implemented according to an operating system or an application program stored in the phone storage unit 140.

In addition, the phone control unit 120 controls each device of the smart pad 200 to operate according to the operating system or the application program implemented in the smart phone 100, in the case where the smart phone 100 is docked on the smart pad 200.

For example, in the case where the smart phone 100 is docked on the smart pad 200, the phone control unit 120 controls the phone input-output unit 110 to be inactivated, that the input-output data is transmitted to the smart pad 200 through the phone communication unit 140 and is input-output in the smart pad 200.

Under the control of the phone control unit 120, the phone communication unit 130 operates as a means to communicate with the smart pad 200 or an external terminal. Especially, the phone communication unit 130 is equipped with an HDMI interface 131 and a USB interface 135, so as to transmit/receive data and signals by communicating with the smart pad 200. Hereinafter, a process of enabling the other terminals to enter into sleep mode as well, in the case that one of the smart phone 100 and the smart pad 200 enters into sleep mode using the HDMI interface 131 will be explained in detail.

A phone storage unit 150 stores an operating system and application programs for driving the smart phone 100.

As aforementioned, through the HDMI interface 131 and USB interface 135 provided in the phone communication unit 130, the smart phone 100 enables screens or voices generated in the smart phone 100 to be displayed or output in the smart pad 200.

Meanwhile, the smart pad 200 comprises a pad input-output unit 210, a pad control unit 220, a pad communication unit 230, and a pad storage unit 240.

Hereinafter the explanation will be focusing on the operations in the case where the smart phone 100 is docked on the smart pad 200.

The pad control unit 220 controls the pad communication unit 230 to enable information exchange and data transmitting/receiving between the smart phone 100 and the smart pad 200. Not only that, the pad control unit 220 controls the pad storage unit 240 to store data received from the smart phone 100 through the pad communication unit 240 or to transmit data stored in the pad storage unit 240 to the smart phone 100.

In the case where the smart phone 100 is docked on the smart pad 200, the pad control unit 220 controls each device of the smart pad 200 to operate according to operating systems and application programs implemented in the smart phone 100.

When the smart pad 200 is not interlocked to the smart phone 100, the smart pad 200 is operated by its separate operating system, but when the smart pad 200 is interlocked to the smart phone 100, the smart pad 200 receives data regarding the operations by the operating system of the smart phone 100 from the smart phone 100 through the pad communication unit 230 and provides the data to the user.

FIG. 4 partially illustrates an architecture layer under an android platform, which is one of the application systems that can be used in the smart phone 100 and the smart pad 200. The android operating system is stored in the phone storage unit 140 of the smart phone 100 and the pad storage unit 240 of the smart pad 200, enabling the smart phone 100 and the smart pad 200 to operate according to the android operating system stored in the smart phone 100 and the smart pad 200.

The android platform refers to a software package which includes a Linux Kernel, HAL (Hardware Abstraction Layer), Library, application framework, and application, and hereinafter, the explanation will focus on the application framework layer and the Linux Kernel layer which are necessary portions in understanding the present disclosure.

The application framework layer is a layer just below the uppermost layer, the application layer. In the application framework layer, there are various controllers that in demon forms and the controllers manage the operating system. Especially in such an application framework, there is an event machine or an event controller.

The event machine which operates in the application framework layer of the smart phone 100 manages a wrapper device driver which will be explained in detail hereinafter and performs the role of managing the events that occur in the smart phone 100 when the smart phone 100 and the smart pad 200 are connected to each other.

In addition, the event controller which operates in the application framework layer of the smart pad 200 performs the role of managing the events that occur in the smart pad 200 when the smart phone 100 and the smart pad 200 are connected to each other.

The lowermost layer is the Linux Kernel layer. Various drivers such as a display driver, a camera driver, and an audio driver are included in the Linux Kernel layer, and the Linux Kernel takes the role of an abstraction layer among the remaining layers of the hardware and the android platform stack.

Meanwhile, the Linux Kernel layer of the smart phone 100 includes a Phone Only Device Driver which is a driver for the devices that exist only in the smart phone 100, and a Same Device Driver which is a driver for the devices that exist both in the smart phone 100 and the smart pad 200.

In addition, in the case where the smart phone 100 already knows a device list of the smart pad 200, the smart phone 100 generates a virtual device driver regarding those devices, and the wrapper device driver manages the interlocked operations of the smart phone 100 by supervising the Same Device Driver and the Virtual Pad Device Driver together.

Meanwhile, hereinbefore the supposition was that the event machine and the event controller exist in the application framework layer, but that was merely for the convenience of explaining the present disclosure. Thus, the technical concept of the present disclosure would also apply to the cases where the event machine and the event controller exist in other layers of the upper layers of the Kernel layer not only in the framework layer. The present disclosure would also apply to the case where the event machine and the event controller exist in the Kernel layer as well.

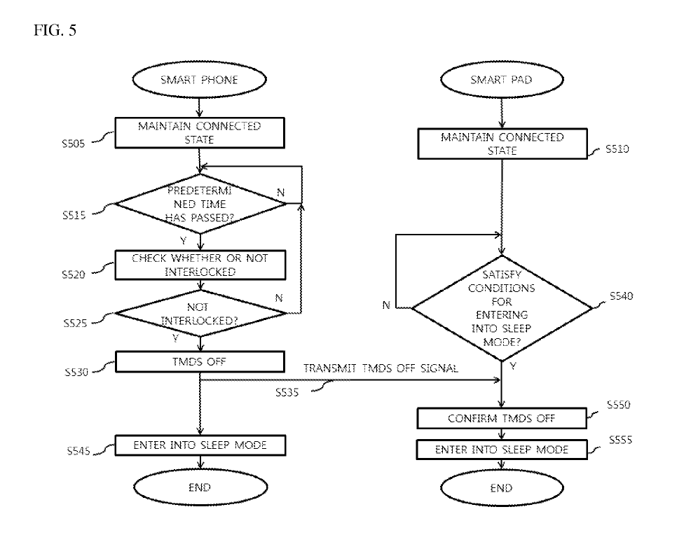

Referring to FIG. 5, hereinbelow is the explanation of a process where the smart phone 100 and the smart pad 200 enter into sleep mode together.

FIG. 5 is a flowchart used to explain a method for enabling the smart pad 200 to enter into sleep mode as well, in the case where the smart phone 100 is to enter into sleep mode.

First of all, before the smart phone 100 and the smart pad 200 enter into sleep mode, it is necessary for both terminals to keep connected (S505, S510). Then, the smart phone 100 determines whether or not a predetermined time set for it to enter into sleep mode has passed.

In the case where the predetermined time has passed (S515-Y), the smart phone 100 determines whether or not there exists an interlocked event with the smart pad 200 (S520). For example, even when the smart phone 100 does not perform any particular operation and thus is in the situation of entering into sleep mode, if data transmitted from the smart phone 100 is displayed on the smart pad 200 or is in process, it would be regarded that interlocked events exist, and thus the smart phone 100 or the smart pad 200 could not be entered into sleep mode.

If it is determined that the smart phone 100 and the smart pad 200 are not interlocked S525-Y, the smart phone 100 would turn off a TMDS signal by controlling a HDMI interface 131 (S530), and enter into sleep mode right away (S545).

When the TMDS signal is turned off (S530), signals related to TMDS OFF will be transmitted to the smart pad 200 (S535).

Meanwhile, before receiving the TMDS OFF signal, the smart pad 200 determines whether or not the smart pad 200 itself is in the condition of entering into sleep mode (S540). In the case where it is determined that the smart pad 200 itself is in the condition of entering into sleep mode (S540-Y), if the smart pad 200 confirms the TMDS OFF through the HDMI interface 231 (S550), the smart pad enters into sleep mode based on the TMDS OFF signal received from the smart phone 100 (S555).

As aforementioned, in the case where the smart phone 100 and the smart pad 200 enter into sleep mode in a connected state, it is unnecessary to perform setting for each docked terminal, and it becomes possible to proceed with the sleep process of the smart pad 200 using the TMDS signal of the HDMI interface alone without going through complex algorithms.

By the aforementioned, the docked terminals can enter into sleep mode together, which enables both terminals to perform interlocked operations instead of operating independently, and thus prevents confusion to users using docked terminals.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method for synchronizing a state of a second terminal to a state of a first terminal in a case where the first terminal is docked on the second terminal through a plurality of interfaces, the state synchronizing method between docked terminals comprising:
determining by the first terminal whether or not the first terminal is interlocked to the second terminal;
turning off signal which the first terminal transmits to a TMDS data line, when it is determined that the first terminal is not interlocked to the second terminal; and
entering by the second terminal into sleep mode, when it is confirmed that the signal received from the TMDS data line is turned off.

2. The method as claimed in claim 1, further comprising:
determining whether or not the second terminal satisfies conditions of entering into sleep mode, and
wherein the entering by the second terminal is characterized in that the second terminal enters into sleep mode, when it is confirmed that the signal received from the TMDS data line is turned off, after satisfying conditions of entering into sleep mode.

3. The method as claimed in claim 1, further comprising:
determining whether or not the first terminal entered into an android sleep state which is applied in the android platform; and
wherein the determining is characterized in that the first terminal determines whether or not the first terminal is interlocked to the second terminal when the first terminal enters into the android sleep state.

4. The method as claimed in claim 1,
wherein the first terminal is characterized to be a mobile phone, and the second terminal is a desktop, tablet PC or laptop which contains space where the first terminal can be docked on, and
information processed in the mobile phone is output in the desktop, tablet PC or laptop when the mobile phone is interlocked on the desktop, tablet PC or laptop.

5. A system for synchronizing a state of a second terminal to a state of a first terminal in a case where the first terminal is docked on the second terminal through a plurality of interfaces, the state synchronizing system between docked terminals comprising:
a first terminal which turns off signal transmitted to a TMDS data line, when it is determined that the first terminal is not interlocked on the second terminal; and
a second terminal which enters into sleep mode when it is confirmed that the signal received from the TMDS data line is turned off when conditions for entering into sleep mode are satisfied.
